(19) United States
(12) Patent Application Publication
(10) Pub. No.: US 2010/0058159 A1
(43) Pub. Date: Mar. 4, 2010

(54) Inline history tracking and contextual display of project specific search histories on the Internet, Intranet or Program

(76) Inventor: Eric May, Boulder, CO (US)

Correspondence Address: Eric May, 560 Brook Rd, Boulder, CO, 80302, US

(21) Appl. No.: 12/547,436

(22) Filed: Aug. 25, 2009

Related U.S. Application Data
(60) Provisional application No. 61/136,296, filed on Aug. 26, 2008.

(51) Int. Cl. G06F 3/14

(52) U.S. Cl. 715/200

(57) ABSTRACT

This is a method of automatically tracking and displaying “Search Histories” inline within the context of an Internet research project. Links to context specific history listings can be displayed contextually within a block diagram and/or within a list. This contextual view of histories facilitates finding and quickly returning to a previously visited web pages. The detailed information about these pages contained in the history pages further facilitates finding the web page of interest. These tools are particularly helpful in the context of an Internet research project.

### FIELD OF INVENTION

The present invention relates generally to the histories used in web browsers.

### BACKGROUND OF INVENTION

While browsers such as Internet Explorer, Firefox and Safari employ a means of recording the history (pages visited during a time period). These histories are not project specific and generally encompass all pages visited during the course of a 24 hr. time period which creates confusion. Browser histories also only record limited information about a web page which makes it difficult to determine which page is the one a user wishes to return to and almost impossible for someone unfamiliar with the search project to guess which pages may contained “missed” information. Further complicating matters these histories are temporary and are usually automatically deleted by the browser or intentionally deleted by the user. Also, since browsers are software, their records are device specific. Allowing the complete history of a research project to be spread across multiple devices and users. As the Internet continues to grow in popularity as a research tool a more advanced system of histories is required.

### SUMMARY OF INVENTION

The inline history system is composed of contextual links within a search project and context specific history listings. This includes a method of automatically tracking, collecting, indefinitely storing and displaying search Histories. Inline links to histories may be displayed contextually within a block diagram and/or within a list. These links may also be a number reflecting the number of pages recorded in the linked history. Histories may contain information about the linked web pages. Collected and displayed information may include: favicons, URLs, page titles, meta data, time and date stamps, duration of time spent on page, user notes and a thumbnail of web page. This information is collected from web pages while browsing the Internet and stored in a database where it is retrievable by the history links and history pages. The collection of history information may be paused during the course of a search reducing the amount pages recorded which may be irrelevant to the search project.

### BRIEF DESCRIPTION OF THE DRAWINGS

FIG. 1: Illustrates Inline History links within a block diagram.

FIG. 2: Illustrates Inline History links within a list.

FIG. 3: Illustrates an Inline History page.

FIG. 4: Diagrams information collection, storage and display.

### PREFERRED IMPLEMENTATION

While an online application is the preferred method for deploying Inline Histories, it is to be understood that this invention is not limited to any particular software, hardware platform. Nor is it a requirement that it be deployed as an online application as it can be deployed as device specific software as well.

### DEFINITIONS

Button: (in a graphical user interface) any of the small, labeled areas upon which the user can click with a mouse to trigger an event or choose an option.

Information Box: a container for information which may be graphical in nature.

Inline History—A recorded history of web pages visited which can be saved and displayed via a link from within the context of a search or research project.

Link—An object, as text or graphics, connected through hypertext to a web page, document, another object, etc.

URL—An acronym for Uniform Resource Locator, which designates the “address” or location of a document or website or web page or other information on the Internet.

Inline History Link—A link within the context of a search or research project which links to a web page containing the history of a search with parameters defined by the context of the project.

Project—An investigation or collection of research findings.

User—A human, agent or other mechanism capable of carrying out a search

### DETAILED DESCRIPTION OF DRAWINGS

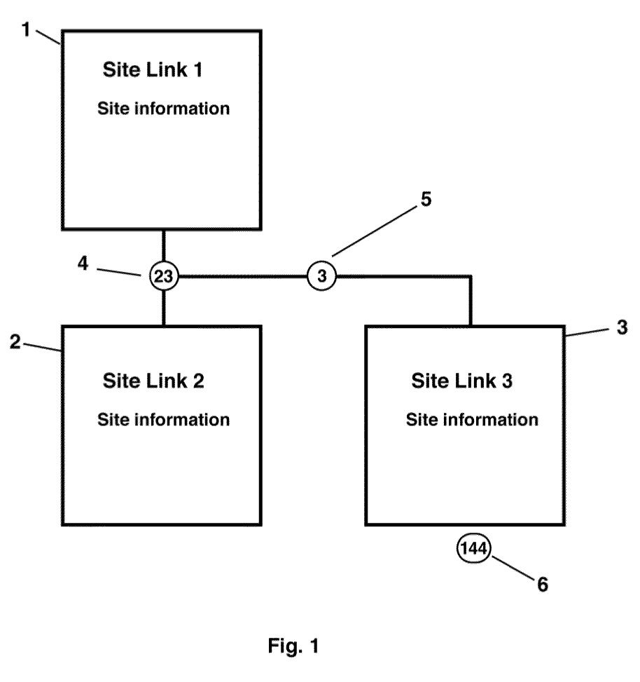

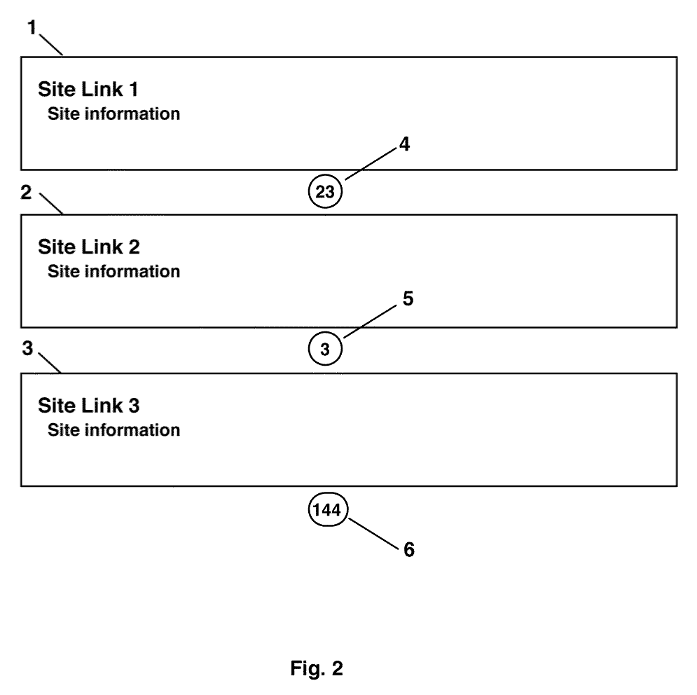

FIGS. 1 and 2 illustrate Inline History links. These links may be represented as numbers providing users with insight as to how many pages have been recorded. Inline history links may be used either in a block diagram record FIG. 1 or in a list FIG. 2. In the following example we use user saved links(information boxes) as the defining boundaries of an inline history, however other “significant” events will work equally as well. In FIG. 1 and FIG. 2 between two user saved links(information boxes) 1, 2 is a history link 4. This button links to an inline history page. The inline history page contains a listing of the web pages visited between the time the first link 1 and second link 2 were saved to the search. If a new line of inquiry leads to the saving of a third (or more) saved link 3 a new inline history link 5 will be created. If the user continues a line of research from the first saved link 1, but does not save a new link the additionally visited pages will be added to the original inline link 4. If a search is continued from an existing saved link 3 that does not result in a saved link a inline history link 6 will be created after the saved link 3.

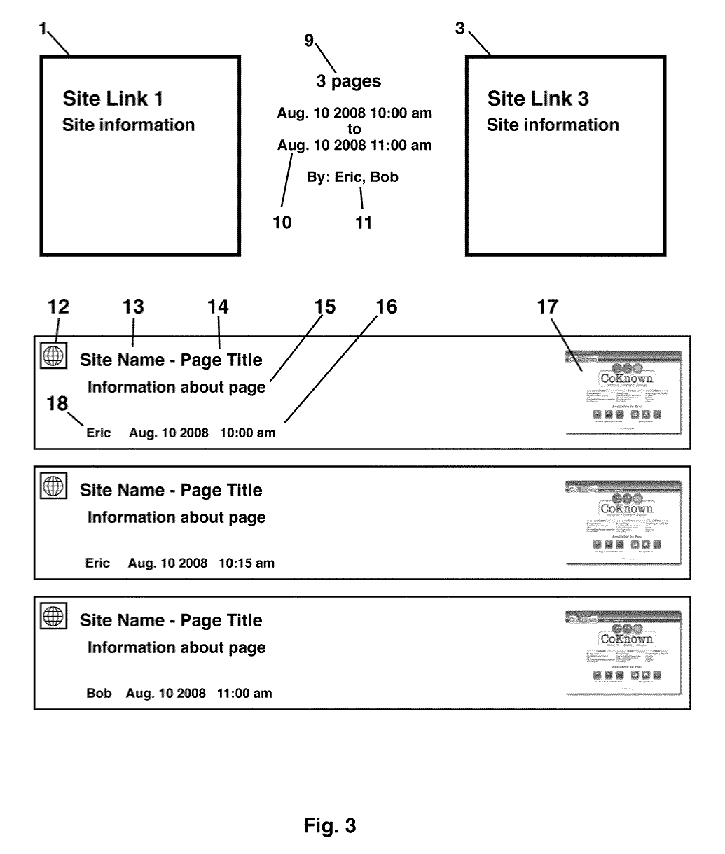

FIG. 3: Illustrates an Inline History page. An Inline History page contains detailed information and links to the web pages that have been visited within the context of a search project.

This page may contain the saved links 1,3 and user defined data as mnemonic devices, as well as time and date stamps for the range of pages displayed 9,10. Also, in a collaborative research project the names of users 11 who have visited these pages may also be displayed. Each history record for a web page visited may contain: Site name 13, page name/title 14, information about the page gathered from meta data or otherwise filtered 15, the name of the user who visited the page 18, a time and date stamp 16, and a thumbnail image of the web page 17. A number of items within this record may be used as links to the original web page 12, 13, 14, 15, 17. These links may open a new window or tab in a browser allowing the original history page to remain in the background. Mnemonic devices, such as the thumbnail 17 may be used to trigger a larger image of the thumbnail to appear. The name of the user 18 may be used as a link to a user profile and/or a rollover state may present contact information. The user name 18 may also be used to indicate whether the user is currently logged into the site. The time stamp 16 may include time(s) and date(s) visited as well as duration of time spent on page. Additional information that may be provided in a history record include links to other projects by the user or other users which include this website or web page, a user(s) defined rating and user generated notes.

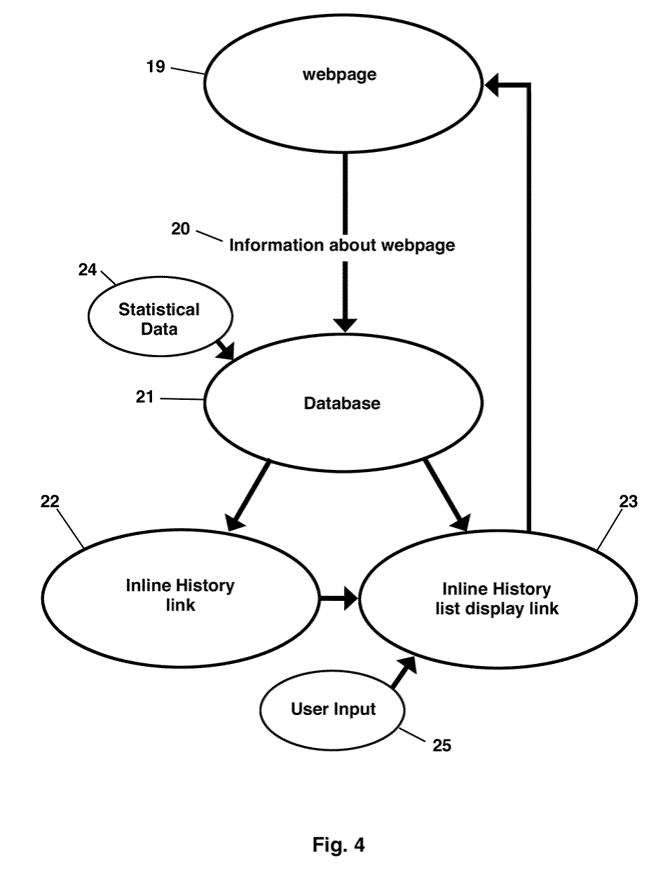

FIG. 4 diagrams a typical information capture storage and display method. A recording method is employed when a web page is visited 19 within the context of a project. This recording method can be started, stopped, paused and resumed by the user, allowing the user to break from a line of research to follow a line of inquiry irrelevant to their current project without introducing these unwanted history records into their project. Information automatically captured from the website 20 may include: Favicons, web page URL, Site URL, page title, meta data, filtered page content and a thumbnail of web page. Statistical data may also be collected such as time and date, duration of time spent on page 24. This information is stored in a database 21 for retrieval and display. The number of pages visited between two user saved links or other “significant” events can be retrieved from the database and displayed as a number inline history link 22. This provides the user with immediate information as to the complexity and duration of a search between the two events as well as the number of pages contained on the history page behind the link. The link opens the relevant Inline History 23. The contextually themed content, quantity and detail of the information gathered about the listed pages provides intuitive accessibility to the user and other users who may view the search history. Notes and ratings may also be added to the inline history 25. The links contained within the Inline history can then be used to go to the listed web pages or sites.

### History of Invention

Original Drawings July 2007

First Non Discloser Agreements signed Oct. 15, 2007

1) A method by which an Internet history is displayed within the context of Internet bookmarks.

2) A method of including Internet histories within the context of a research project.
